(19) United States
(12) Patent Application Publication
(10) Pub. No.: US 2004/0093293 A1
(43) Pub. Date: May 13, 2004

(54) SAM rating matrix system and method thereof

(76) Inventor: Timothy Man Yau Cheung, Hong Kong (CN)

Correspondence Address: Raymond Y. Chan, Suite 128, 108 N. Ynez Avenue, Monterey Park, CA, 91754, US

(21) Appl. No.: 10/288,716

(22) Filed: Nov. 7, 2002

(51) Int. Cl. G06F 17/60

(52) U.S. Cl. 705/36

(57) ABSTRACT

A standard audit manual (SAM) rating matrix system includes a rating matrix model established base upon a standard audit manual by evaluating of internal controls to determine an internal control rating value, appraising a likelihood of potential errors and material misstatement to determine an error rating value, appraising a professional risk to determine a risk rating value, and appraising a materiality guideline to determine a guideline rating value. Therefore, an audit rating value is evaluated in accordance with said rating matrix model to implicate a level of likelihood of errors and a risk level of misstatement so as to derive an overall assessment and evaluation and forms bases of formulating an audit approach for each audit engagement.

### BACKGROUND OF THE PRESENT INVENTION

1. Field of Invention

The present invention relates to a standard audit manual (SAM) rating model, and more particularly to a SAM rating matrix system and method thereof, which can substantially help the auditors/audit firms to formulate approach in an objective, consistent and unbiased manner for all audit engagements.

2. Description of Related Arts

As state in Statement of Auditing Standards ASA 100 “Objective and general principles governing an audit of financial statements”, the objective of an audit is to enable auditors to express an opinion on whether the financial statements are prepared, in all material respects, in accordance with an identified financial reporting framework and are free from material misstatements. Also, SAS 470 “Overall review of financial statements” state that “the auditors should consider whether the information presented in the financial statements is in accordance with relevant statutory requirements and whether the accounting policies employed are in accordance with applicable accounting standards and guidelines, properly disclosed, consistently applied and appropriate to the entity.”

As shown in FIG. 1, the standard audit manual in normal audit practice comprises the following steps.

(A) Plan an auditing procedure to understand the audit engagement, the business and to design the audit approach based upon the necessary auditing information and the evaluation of internal controls.

(B) Perform a system test to provide a basis for assessing the likelihood of errors in the financial statement.

(C) Complete the audit as a whole in order to be able to reach an appropriate opinion on the information on which the auditors are to report.

Before an audit is completed, there are eight major audit objectives must be satisfied. The eight audit objectives are the following.

Classification—transactions are properly classified

Cutoff—amounts are recorded in the proper financial period

Accuracy—mechanical accuracy refers to the amounts being correctly recorded, posted and summarized

Valuation—amounts are properly valuated with changes in circumferences

Existence—all amounts are recorded (completeness) and valid

Disclosure—all information are properly disclosed and presented in accordance with appropriate statutory and regulatory requirements

Ownership—assets are beneficially owned

GAAP—comply with general accepted accounting principles

However, potential errors may possible made in accordance with the audit objectives.

Objectives Potential Errors

Classification—transactions are improperly classified

Cutoff—transactions are recorded in the wrong accounting period

Accuracy—transactions are incorrectly posted or summarized

Valuation—transactions are improperly valued

Existence—completeness—transactions are not properly authorized and recorded—validity—transactions are invalid

Disclosure—non-compliance of disclosure requirements—non-disclosure of material items

Ownership—assets are not beneficially owned

GAAP—financial statements are not properly prepared with general accepted accounting practices

In the normal audit practice, most audit approach/procedure are adopted subjectively by the auditor. Therefore, the present audit practice has several drawbacks as follow.

1. The opinion that the auditor made is based on his or her own experience and the completeness of the material items such that potential errors may occur during the audit approach/procedure, especially when the auditor has insufficient auditing knowledge.

2. Due to the subjectively opinion, the auditing approach/procedure is relied on the auditor who forms the opinion of the financial statement. Therefore, the conduct of the auditor who in charges the auditing approach/procedure becomes one of the major factor of the reliability of the opinion and the accuracy thereof.

3. Moreover, the subjectively opinion may bring a conflict between auditors. In other words, each auditor has his or her own auditing methodology based upon his or her experience to evaluate the audit approach/procedures even though there are some practice guidelines, such as Statements of Auditing Standards or Statements of Standard Accounting Practice, to follow.

4. A system test and a verification process may applied in the audit approach/procedure to minimize the errors thereof. However, the auditor must use his or her experience rather than the standardized system to point out the error. Therefore, mistakes of judgment may be made by the auditor concurrently.

5. No standardized auditing methodology is set such that the auditor has difficulty to analyze the previous opinion especially it is not made by the same auditor. It is a time and labor consuming process for the auditor to re-organize all the necessary material items to form the opinion of the financial statement that is based on the previous one.

6. In such complicated auditing procedure, no all the audit staff can totally understand each step of the procedure. Therefore, in order to build up the audit knowledge, the audit staff, especially the auditor trainee, needs to learn from the senior auditors year after year so as to gain enough auditing experience.

It is worth mentioning that the auditors are responsible for forming and expressing an opinion on the financial statements, such that any mistake that the auditor made may cause serious problem to both the auditor firm and the client.

### SUMMARY OF THE PRESENT INVENTION

A main object of the present invention is to provide a standard audit manual (SAM) rating matrix system, wherein an audit rating value is determined to derive an overall assessment and evaluation and forms the bases of formulating an audit approach for each audit engagement.

Another object of the present invention is to provide a standard audit manual (SAM) rating matrix system, which provides a methodology for evaluating which audit procedures/approach to use for each audit engagement by assessing the reliability of internal controls of client's operation and management and the likelihood of errors or material misstatement in the financial statements, the appraisal of professional risk and materiality. In other words, the SAM rating can help the auditors/audit firms to formulate approach in an objective, consistent and unbiased manner for all audit engagements.

Another object of the present invention is to provide a SAM rating matrix system, which can guide the auditors to gather sufficient, relevant and reliable evidence so as to provide reasonable assurance to form an opinion that the financial statements are free from material misstatements and give a true and fair view.

Another object of the present invention is to provide a SAM rating matrix system, which is aimed to develop general conceptual and technical bases of an audit so that the auditor is able to perform the audits in a consistent manner and to provide guidance on the objectives and general principles governing an audit.

Another object of present invention is to provide a SAM rating matrix system, which provides a mutual benefit for the client and the audit firm. The SAM rating model is capable of not only helping the client to obtain an opinion on the financial statements and the minimum disclosure of the relevant information as required by statutory, regulatory and other relevant requirements but also serving the audit firm to clearly document the professional standards thereof.

Another object of the present invention is to provide a SAM rating matrix system, which can be used in the audit systems (both external and internal), or for internal credit control purpose that corporations is capable of building up and evaluating their internal control system.

Another object of the present invention is to provide a SAM rating matrix system, which works as a practice guideline to clearly communicate among professional staff, clients and other professionals. In other words, the auditor is able to map out the financial statement of the client easily even though the financial statement is done by other auditor.

Another object of the present invention is to provide a SAM rating matrix system, wherein even though company's accounts, operation systems and internal control vary from one company to another, professional staffs are also reminded to apply their professional judgment within the guideline of SAM of the present invention.

Another object of the present invention is to provide a SAM rating matrix system, which can be treated as audit training materials such that a well documented and standardized methodology of the present invention helps to train audit staff more effectively and efficiently so as to easily build up his or her auditing knowledge and to foster an effective and efficient client service.

Accordingly, in order to accomplish the above objects, the present invention provides a standard audit manual (SAM) rating matrix system, which comprises:

a rating matrix model established base upon a standard audit manual by evaluating of internal controls to determine an internal control rating value, appraising a likelihood of potential errors and material misstatement to determine an error rating value, appraising a professional risk to determine a risk rating value, and appraising a materiality guideline to determine a guideline rating value; and

means for evaluating an audit rating value in accordance with the rating matrix model, wherein the audit rating value implicate a level of likelihood of errors and a risk level of misstatement to derive an overall assessment and evaluation and forms bases of formulating an audit approach for each audit engagement.

The present invention also provides a method of SAM rating matrix system, which comprises the steps of:

(a) establishing a rating matrix model, based upon a standard audit manual, by:

(a.1) evaluating of internal controls to determine an internal control rating value;

(a.2) appraising a likelihood of potential errors and material misstatement to determine an error rating value;

(a.3) appraising a professional risk to determine a risk rating value; and

(a.4) appraising a materiality guideline to determine a guideline rating value; and

(b) evaluating an audit rating value in accordance with the rating matrix model, wherein the audit rating value implicate a level of likelihood of errors and a risk level of misstatement to derive an overall assessment and evaluation and forms bases of formulating an audit approach for each audit engagement.

### BRIEF DESCRIPTION OF THE DRAWINGS

FIG. 1 is a flow chart illustrating a standard audit manual of a normal audit practice incorporated with a SAM rating matrix system according to a preferred embodiment of the present invention.

FIG. 2 is a flow chart illustrating a method of SAM rating matrix system according to the above preferred embodiment of the present invention.

FIG. 3 is a table illustrating a rating matrix model of the SAM rating matrix system according to the above preferred embodiment of the present invention.

FIG. 4 is a table illustrating an audit rating value of the SAM rating matrix system according to the above preferred embodiment of the present invention.

FIG. 5 is a flow chart illustrating the decisions on the performance of Phase II procedures according to the above preferred embodiment of the present invention.

FIG. 6 is a flow chart illustrating the decisions in planning Phase II tests according to the above preferred embodiment of the present invention.

FIG. 7 is a flow chart illustrating the workflows of Phase III according to the above preferred embodiment of the present invention.

### DETAILED DESCRIPTION OF THE PREFERRED EMBODIMENT

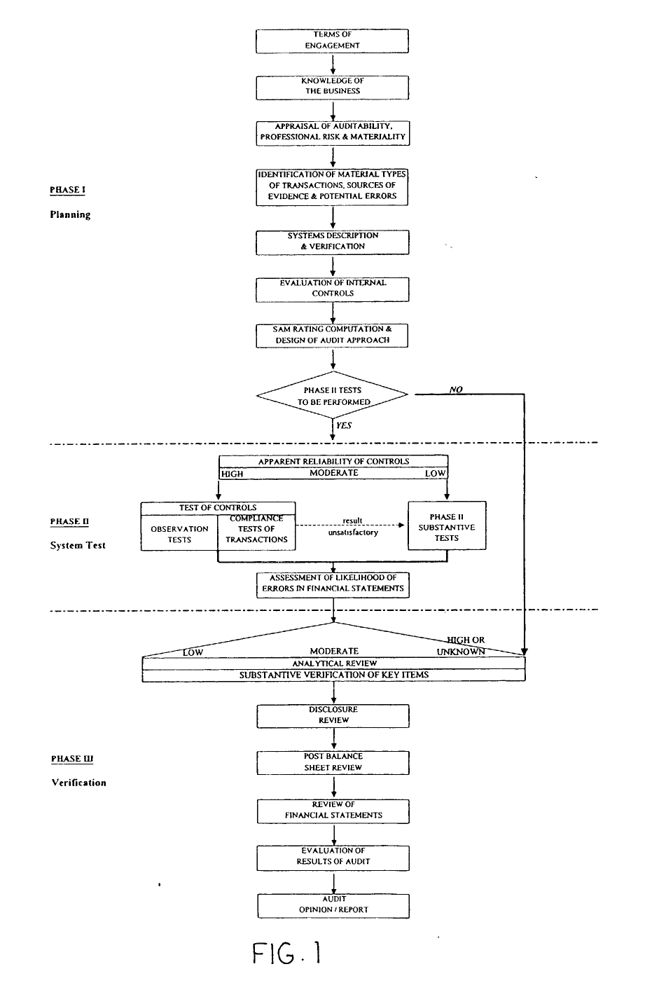

Referring to FIG. 1, a SAM rating matrix system according to a preferred embodiment of the present invention is illustrated, wherein the SAM rating matrix system, which is a sequence of audit activities in an establish order, is aimed to ensure that the auditors neither omit necessary audit procedures (under audit) nor perform unnecessary ones (over audit).

As shown in FIG. 1, the SAM rating matrix system comprises a rating matrix model and means for evaluating an audit rating value in accordance with the rating matrix model.

The rating matrix model is established base upon a standard audit manual by evaluating of internal controls to determine an internal control rating value, appraising a likelihood of potential errors and material misstatement to determine an error rating value, appraising a professional risk to determine a risk rating value, and appraising a materiality guideline to determine a guideline rating value.

The audit rating value implicate a level of likelihood of errors and a risk level of misstatement to derive an overall assessment and evaluation and forms bases of formulating an audit approach for each audit engagement.

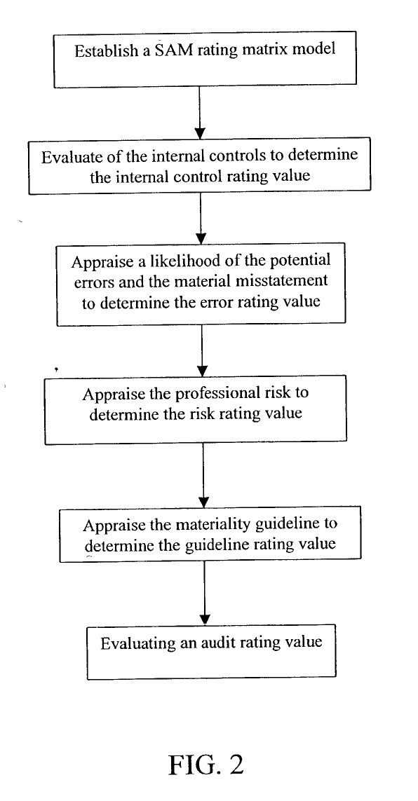

As shown in FIG. 2, a method of SAM rating matrix system is illustrated, wherein the method comprises the steps of:

(1) establishing the rating matrix model, based upon the standard audit manual, by:

(1.1) evaluating of the internal controls to determine the internal control rating value;

(1.2) appraising a likelihood of the potential errors and the material misstatement to determine the error rating value;

(1.3) appraising the professional risk to determine the risk rating value; and

(1.4) appraising the materiality guideline to determine the guideline rating value; and

(2) evaluating the audit rating value in accordance with the rating matrix model, wherein the audit rating value implicate a level of likelihood of errors and a risk level of misstatement to derive an overall assessment and evaluation and forms bases of formulating an audit approach for each audit engagement.

According to the preferred embodiment, the SAM rating matrix system can be embodied as an auditing program for standardizing the normal audit practice, so that the auditors are capable of following the steps of the SAM rating matrix system to complete the auditing procedure. The SAM rating matrix system is preferably stored and saved in the central processor unit wherein the central processor unit can also be locally stored in an electronic computing device, such as a personal computer, such that the auditor is able to access the SAM rating matrix system at office for auditing purpose. Moreover, the result of the SAM rating matrix system will be recorded so that the auditor can use the record as a reference even though the record is done by other auditors.

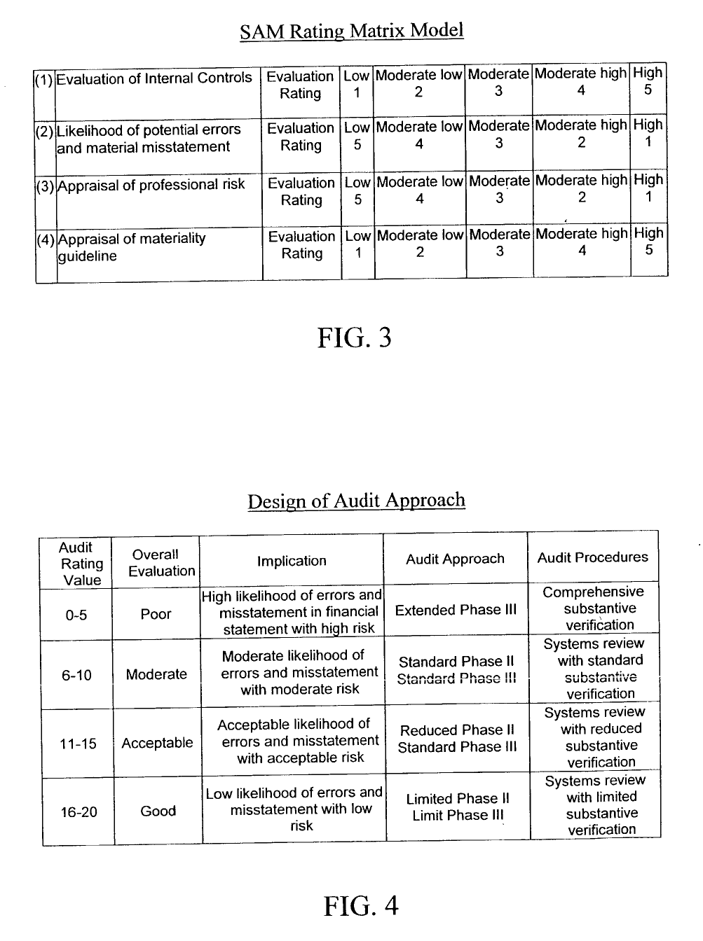

Each of the rating values in the rating matrix model is graded at five ratings which are low, moderate low, moderate, moderate high, and high. As shown in FIG. 3, the rating of each of rating values worth a predetermined point value such that the audit rating value can be simply determined by summing up the point values of the rating values. Preferably, the SAM rating matrix model and the evaluating means are displayed in a “spreadsheet format”, so that the auditor is able to input the rating values of the SAM rating matrix model to automatically calculate the audit rating value.

Accordingly, the standard audit manual comprises the following steps.

(A) Establish a materiality guideline for audit evaluation of monetary errors.

(B) Identify material types of transactions, the sources of evidence and their potential errors.

(C) Know the client's accounting systems and controls.

(D) Verify the systems by “walkthrough” procedures wherein at least one material type of transaction is traced.

(E) Evaluate the internal controls, the competence of accounts staff in operation in order to evaluate the degree of reliability of the systems.

The auditors should evaluate the internal controls in order to determine their apparent reliability in preventing or detecting and correcting potential errors. This evaluation will enable the auditors to plan the extent to which internal controls will be relied upon, and therefore it is a critical step in the design of the audit approach.

The detailed accounting objectives of the internal control can be grouped into the following categories:

a. Controls that ensure completeness—i.e., that transactions are valid, recorded and that sufficient evidence exists to support the audit approach.

b. Controls that ensure transactions are properly authorized.

c. Controls that ensure accuracy—i.e., that transactions are properly valued, classified, summarized, recorded in the correct period.

The concept of auditability requires the auditors to rely upon some internal controls to satisfy themselves that all transactions are recorded in the client's books, and that sufficient appropriate audit evidence is available for examination. Consequently, the evaluation of the reliability of the controls that ensure completeness constitutes the minimum evaluation of internal control. If the auditors plan to rely on internal control for potential errors that relate to accuracy and authorization, the auditors will have to expand the study to identify and evaluate the internal controls that either prevent, or detect and correct, these potential errors.

Regardless of the extent of the evaluation of internal controls, a complete understanding of the client's system will always be required. Moreover, the auditors may extend the evaluation beyond that needed for audit scope purpose in order to develop recommendations to the client for improvements in systems.

The system description will enable the auditors to identify where apparently reliable controls exist to prevent, or detect and correct, errors, and also where controls appear unreliable and errors could occur and not be detected. It should be emphasized that this evaluation of internal controls is preliminary, as it is based on the controls as the auditors believe then to be operating. As a result of the evaluation the auditors will make assumptions about the reliability of the accounting data processed by the systems, and it will be necessary to test the evaluation in order to determine whether the controls have in fact been operating during the period as the auditors believe.

Much of the audit evidence will be produced by the systems on an ongoing basis, whereas other evidence will be produced periodically. For the purposes of evaluating internal controls, the auditors will normally be concerned with audit evidence only annually would be examined as part of the verification procedures.

The following steps constitute the process required for the evaluation of internal controls:

a. Identify the potential errors that could occur in the transactions being processed.

b. Analyze the systems descriptions to identify the controls which should prevent, or detect and correct, such errors.

c. Evaluate the apparent reliability of the controls in preventing or detecting and correcting potential errors on a timely basis.

d. Identify potential errors which appear to be inadequately controlled.

Accordingly, the internal controls is evaluated by transaction walk though tests, wherein the transaction walk through tests are performed by selecting a small number of transactions (one to three) and following them through the system to determine whether they have been processed in the manner described. The transactions may be followed from initiation to final processing (“cradle to grave”) or vice versa. The choice of direction is one of convenience and practicality.

Having identified potential errors, auditors should now consider whether the systems description indicates that controls exist which either prevent, or detect and correct, such errors. Controls may exist at both the systems level and the corporate level and therefore both levels must be considered.

It should be remembered that there will often be some overlap between different systems, and the auditors should always be alert to features in another system which may have an effect on the internal controls in the system the auditors are evaluating.

The likelihood of errors is evaluated by observation and compliance tests. If the performance of a control leaves no documentary evidence, the only method of testing the reliability of the control is by observation. The observation tests will often be accompanied by supplementary inquiries, particularly as to the operation of controls at other times, and also about the way the control is being performed at the time it is observed.

Observation tests can be very useful in providing evidence about the reliability of the current performance of a wide variety of controls, and should be included in the planning on most audits. Even when little reliance on controls is planned, observation tests can provide audit evidence about the quality of Company's accounting organization and records.

If the performance of a control does leave documentary evidence, the auditors can examine the evidence of compliance with the control procedure. The tests will be designed to detect “compliance deviations”. A compliance deviation is a failure to perform an internal control procedure, regardless of the amount of the transaction or whether there is any monetary error.

In designing a compliance test of transactions, the auditors must define carefully what will constitute a compliance deviation for that particular test. For example, if the auditors are testing the control which matches shipping documents to sales invoices and checks that all goods shipped have been billed, the definition of a compliance deviation should include as lack of evidence of the check, both an unmatched shipping document, and a shipping document matched to the wrong sales invoice, since in each case the control would not constitute a compliance deviation for that particular control. However, any monetary errors discovered during a compliance test cannot be ignored. Since they provide evidence of errors in the financial statements, they must be included in the assessment of the likelihood of errors for accounts involved.

It should now be possible to evaluate the likelihood that potential errors will occur and not be prevented or detected by the controls (and therefore will remain uncorrected). The evaluation can only be made in terms of the apparent reliability of controls, since it will be necessary to carry out the substantial tests to finalize the evaluation and enable the auditors to assess the likelihood of errors in the financial statements. It is appropriate to express the internal control rating values as the evaluation of the apparent reliability of controls into 5 ratings as follows:

a. High—where internal controls are apparently reliable and no material errors are expected to remain in the records of transactions or events.

b. Moderate high—when internal controls are reliable and material errors in the financial is low.

c. Moderate—where internal controls are apparently moderately reliable and, although some errors are expected, they are not expected to cause a material error in the financial statements and thus acceptable.

d. Moderate low—when internal controls seem not reliable and errors might occurs.

e. Low—where internal controls are apparently unreliable and may errors are expected.

The above evaluation will be used as the basis for planning the audit approach. It is important to remember that the evaluation is for each potential error type. It is possible to have:

a. A mixture of evaluations within any one system.

b. Controls which are superfluous and, although identified and included in the evaluation, need not be considered further for audit purpose.

Certain error types may appear to be uncontrolled when they are traced through the systems descriptions, or there may be some controls which are considered inadequate for purpose of reliance. The absence of specific controls does not mean that errors are actually occurring: it means that evidence about controls is not available to support the contention that information is reliable. In such circumstances, substantive evidence must be gathered about the accuracy of the information itself, either by examining the details of transactions for monetary errors or by examining details of account balances.

The implication of an incorrect evaluation of internal control is that the auditors may design an inappropriate audit which would cause the auditors to do significantly more work than is necessary. This is because:

a. If the auditors evaluate internal control as good when, in fact, it is bad, the auditors would likely to waste time in designing and carrying out tests of control which prove to be unsatisfactory.

b. If the auditors evaluate internal control as bad when, in fact, it is good the auditors would opt for extended substantive testing whereas tests of controls might have been a more efficient approach.

It should be appreciated, therefore, that the evaluation of internal control is critical part of the audit process and must be carried out by a suitably experienced member of the audit team.

As already mentioned, where changes in the systems have occurred during the year, the auditors must describe and verify both the old system. Similarly, the auditors must evaluate both systems to determine whether internal controls have been affected by the change. In some circumstances the auditors may have to design a different audit approach for the new and the old systems.

The above process of evaluation applied equally to internal controls in manual, mechanical and in computerized system. The examples of potential errors do no cover the specific problems that arise when a computer forms part of an accounting system.

It is important that to consider the potential errors which might exist for each transaction type. For transactions that are processed through formal accounting systems, this identification of potential errors will be performed as part of the evaluation of internal control. For transactions that are not processed though formal accounting systems, the identification of potential errors provides important input for planning appropriate substantive procedures.

Having identified potential errors in previous procedures, it is more practically to refer the errors to specific risk areas especially those high risk areas for the purpose of planning appropriate substantive procedures.

The evaluation process is to identify the potential errors that could occur in the transactions being processed in each system. The followings are seven general potential errors types which can be used for this purpose:

a. Recorded transactions are invalid.

b. Transactions are not recorded.

c. Transactions are not properly authorized.

d. Transactions are improperly valued.

e. Transactions are improperly classified.

f. Transactions are recorded in the wrong period.

g. Transactions are incorrectly posted and/or summarized.

There are five conditions to identify the professional risk, wherein the five conditions thereof are general economic and financial conditions, organizational conditions, management's integrity and honesty, shareholding and management structure, and client's past record.

According to the general economic and financial conditions, when investors or creditors lose money, it is common for them to seek recovery through claims that they relied upon audited financial statements which failed to provide them with information which would have influenced their decisions and enabled them to avoid their losses. Regardless of the validity of such claims, the auditors should recognize that a client which has an economic downturn represents a potential professional risk and the auditors should therefore identify early warning signs of potential economic downturns.

The organizational conditions are that a weak management organization, or poor managerial performance or control, may well result in economic downturn for the client and may also pressure management into defensive business decisions which are not in the best overall interest of the client.

The integrity of management and the need for management to act in good faith toward the auditors is fundamental to the ability to perform an adequate audit. The competence of the management is also indicator. It management does not meet these conditions, there is a professional risk that management will circumvent the client's system for the proper recording of transactions, with the result that the client's financial statements will be misleading or fraudulent. It is important, therefore, that the auditors endeavor to understand the motives of management towards certain objectives.

Shareholding and management structure might give indication of different level of professional risk. The greater the complexity of the structure, the higher the professional risk would be as disputes were normally resulted.

The auditor's experience in respect of the client's record brings tremendous reference to the evaluation of professional risk. A past record of negative performance in respect of the client increase the professional risk to a certain extent. The longer the period of establishment, the higher the creditability gained by a company.

After identifying the above conditions of the professional risk, the auditors must consider whether the risks are such that the auditors are unwilling to accept them, or whether the auditors should take some special action to protect themselves against some particular risk. The auditors may conclude, for example, that the uncertainties created by a professional risk can be diminished to an acceptable level by audit procedures designed to provide sufficient audit evidence for that purpose. If the auditors are unwilling to accept the level of professional risk, then the auditors will take appropriate action.

Materiality is defined as an item, or group of items, is material to a set of financial statements if there if a reasonable prospect that the quantitative or qualitative nature of the item or items would be significant to the decisions of a user of the financial statements or misstatement of the financial statements to a significant extent.

Different users of financial statements have different interests in the financial position and results of operations, and therefore they have different criteria as to materiality. For example:

a. Shareholders are most likely to be interested in net profit and conditions affecting a company's ability to pay dividends or to generate cash for reinvestment.

b. Short-term creditors are most likely to be interested in the liquidity of a company's net assets and the coverage of its debt.

c. Secured long-term creditors are most likely to be interested in a company's ability to generate the necessary funds to pay interest and principle, and in the security for the debt.

d. Other users—bankers, tax authorities, news investors, etc.

The above discussion illustrates that materiality involves both quantifiable measurements and subjective evaluation of the importance of items under consideration. Thus, although our appraisal of materiality would be simpler if all materiality guidelines were quantitative, the auditors must also consider qualitative factors.

It is helpful to have some quantitative guidelines as a basis for decisions. It is considered that an effect of 5% or more is presumed to be material, and an effect of less than 5% is presumed to be immaterial, in the absence of qualitative factors to the contrary. The 5% should be measured in relation to the base appropriate in the circumstances. Sometimes there will be more than on base to which a particular account balance, transaction or item should be compared, in which case the auditors should use the lower. Although the specific base to be used depends on the composition of the company's financial statements, the following guidelines are useful:

Balance or Transaction Usual Measurement Base

Current Asset and Liability Balances:

For error not affecting net profit a. Current assets or current liabilities

b. Total assets

For errors affecting net profit Profit before taxes

Long-term debt:

For errors not affecting net profit a. Total liabilities

b. Total assets

For errors affecting net profit Profit before taxes

Property, plant and equipment and other non-current assets:

For errors not affecting net profit Total assets

For errors affecting net profit Profit before taxes

Components of shareholders' equity Shareholders' equity

Total revenue, components of revenue Profit before taxes

Individual expense account balances Profit before taxes or total expenses

It is emphasized that these quantitative measurements are subject to qualitative factors. For example, the auditors must consider whether the size of the base used is appropriate. If the profit before taxes is abnormally low in relation to revenues, the 5 criterion of 5% is likely to produce an unrealistically low guideline and another base would be more appropriate. Where profit before taxes fluctuates considerably from year to year, it may be more appropriate to base materiality on, say, a two-year or a three-year average.

Similarly, an amount that is immaterial quantitatively might be regarded as 10 material in circumstances such as the following:

a. A transaction involving related parties

b. A transaction involving a conflict of interests.

c. A transaction that appears to be illegal.

d. A transaction involving irregularities

e. An item that has special significance in the current business, economic or political climate.

f. An item that is unusual in relation to normal operations.

g. An item that is a symptom of a mush greater concealed operating—e.g., sales returns, product warranty developments.

h. An item which reflects a possible breach of contractual obligations.

i. A transaction of balance which is large in absolute monetary terms (i.e., although not material to the client's financial statements it would be material form the view of the man in the street).

j. An item which is expected to have a material effect on some future periods.

k. An item which is required to be disclosed by statute or regulatory authority.

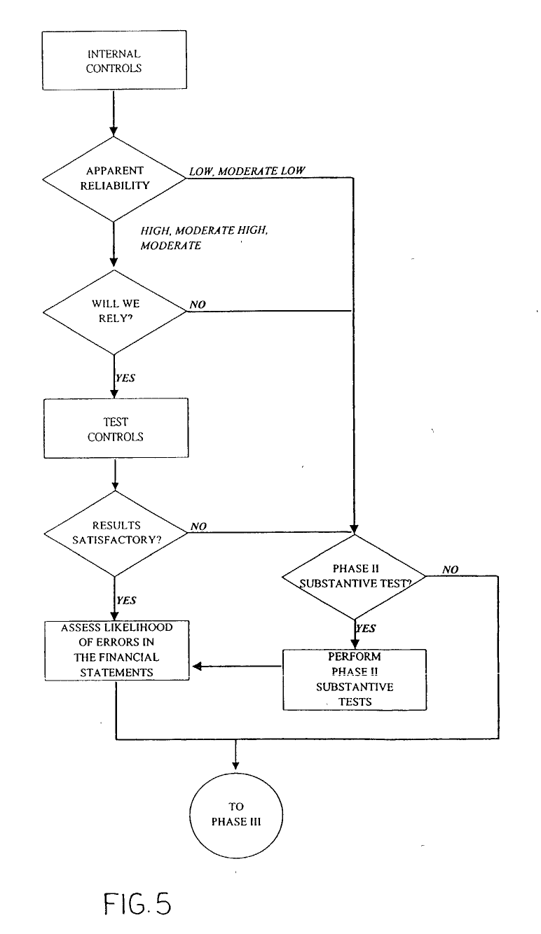

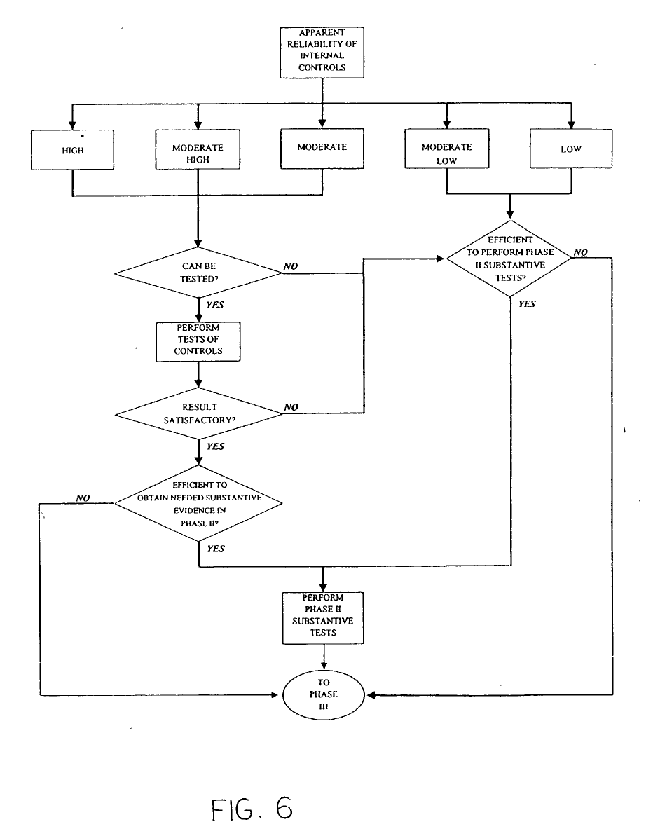

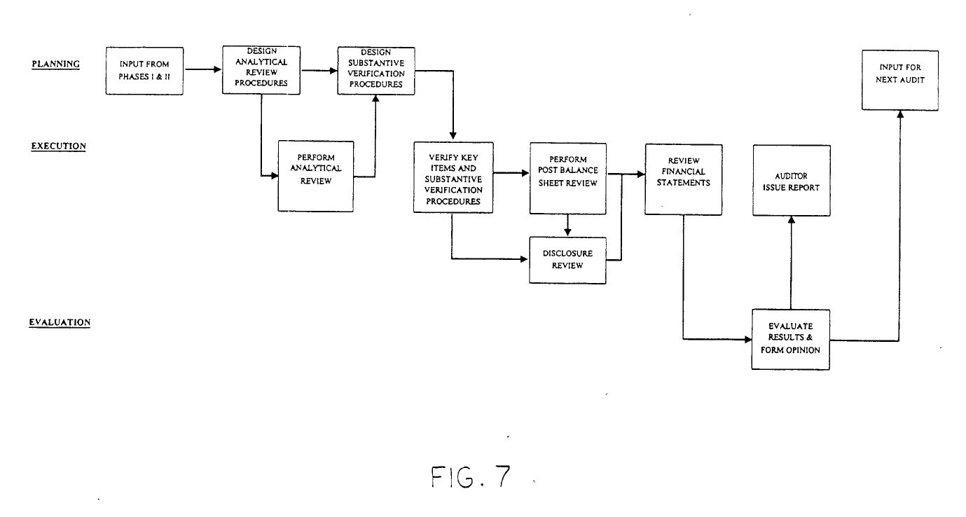

As per SAM matrix model, a total of 20 audit rating value is noted by summing up the rating values of the SAM matrix model. The evaluation and implication of the audit rating value and the associated SAM procedure is exhibited as shown in FIG. 4.

The method of SAM rating matrix further comprises a step of:

(3) Design the audit approach based upon the audit rating value, so as to selectively perform a system test and verification and adjust extents of the system test and verification.

After evaluating the audit rating value, which is considered as a Phase I of the entire audit procedure, the audit approach is specifically designed based on the audit rating value to Phase II or/and Phase III for the system test and verification respectively. In other words, the decision so to whether to perform both Phase II and Phase III substantive tests, or to perform Phase III procedures exclusively, is important and depends upon the computation of audit rating value and also the efficiency of the procedures planned.

On the assumption the auditors have decided that the client is auditable and the professional risk entailed in the engagement is acceptable, the first decision in the process of designing the audit approach will be whether to rely on internal controls for some potential errors. This decision is of prime importance because it will determine to great degree the effectiveness and efficiency of the audit.

If, for a particular error type, the auditors decide that it would be effective and efficient to rely on internal controls, the auditors will design tests of controls to corroborate the evaluation of the apparent reliability so that substantive tests may be kept to a minimum.

For potential errors where the auditors decide not to rely on internal controls, the auditors will design substantive tests. The auditors must decide whether it will be more effective and efficient either to perform the system test in Phase II, assess the likelihood of errors in the financial statements, and keep the verification in Phase III to a minimum, or to perform only the substantive procedures.

In other words, the audit approach will be the basis for the design of detailed audit procedures to be performed in Phases II and III. As procedures are performed and results are obtained, the plan will provide a framework for making audit judgments. Where basis; where unexpected results are obtained, the audit plan will be used to determine the appropriate changes that are necessary.

A main purpose of presenting the audit plan is to ensure the consistency of all the detailed plans being formulated for work to be done. The plan provides a major review point for the engagement partner and serves to communicate the overall approach to all members of the audit team.

The workflow shown in FIG. 5 illustrates the activities involved in Phase II of the audit process and distinguishes between the functions of planning, execution, and evaluation. The workflow also identifies likely responsibilities by level of engagement personnel for each activity, and suggests the probable form of documentation.

The decision to perform Phase II procedure was made in Phase I in accordance with the audit rating value. The objective of the Phase II procedures is to provide a basis for assessing the likelihood of errors in the financial statements. There are two types of Phase II procedures—test of controls and substantive tests—and as their descriptions imply, they achieve their common objective differently. Where internal controls are apparently reliable our Phase II procedures normally will be test of controls. Where internal controls are apparently not reliable our Phase II procedures will be substantive tests.

Accordingly, the purpose of the test of controls is to determine whether those controls identified in the evaluation of internal controls as apparently reliable, and selected as useful for audit, have been operating reliably during the period under review. Where the auditors find that they have, this will corroborate the evaluation of internal controls, and, in the absence of evidence to the contrary, the auditor will be able to assess the likelihood of errors in the financial statements as low. This will enable the auditors to conduct the Phase II detailed verification procedures as planned.

When the tests of control are preformed and the results are satisfactory, then the initial evaluation of internal control is corroborated and the auditors can use these results in assessing the likelihood of errors in the financial statements.

The purpose of the substantive tests are to determine whether the transactions being processed through the client's system contain monetary errors. Phase II substantive tests are performed on date selected from the transaction streams, or they can be performed on interim account balance into which the transactions flow, and they include analytical review. Furthermore, the auditors may initiate the examination of key items of material transaction types in Phase II.

The objective of the verification in Phase III is to complete the audit as a whole, in order to able to reach an appropriate opinion on the information on which the auditors are to report. Phase III, therefore, is the final stage of the audit, and the results of the work that the auditors have performed in Phases I and II will be primary input in establishing the scope of the Phase III procedures.

The auditors should review the information obtained during Phase I to determine if any of it should be updated and reconsidered at the Phase III planning stage. In particular the auditors should reassess the appraisal of auditability, professional risk and materiality and continue the identification of any additional material types of transactions, sources of evidence and potential errors.

There are two types of procedures will be used in Phase III—analytical review and substantive verification of key items. FIG. 7 illustrates the relationship between these two types and how they contribute to the audit evidence required from Phase III tests.

The analytical review is, as its name implies, a review as opposed to a test. The review is made of the relationship between account balances, the overall reasonableness thereof, and comparisons of these relationships with those of prior years and information from industry data. Normally, specific ratios and trends are important items which are identified, evaluated and compared to prior years' and industry data. Analytical review procedures consider the “reasonableness” of the data, and are particularly useful in identifying areas that appear “unreasonable” and that will require additional verification procedures. Besides, the overall consistency of the information and data presented in different items of the financial statements is also important. Thus, the results of analytical review procedures will provide input to the decisions on the selection and extent of the additional verification procedures, and will also provide useful audit evidence. However, analytical review procedures are generally not sufficient for material account balances, and should be accompanied by other Phase III procedures. An important advantage of analytical review procedures is that generally they are less time consuming than verification of details.

The key items in the substantive verification must be verified individually, no matter how good internal control may be as specific audit objectives, e.g. ownership, may not be fully achieved in Phase I and II. Once a key item or material transaction has been identified, substantive audit procedures must be designed for all potential errors for specific transactions and account balances. Some of these procedures may have been performed in Phase II. A checklist of the audit procedures usually referring to audit program is illustrated in the Firm's other booklet “Standard Audit Manual—Guideline”.

It is not possible to specify the particular procedures that must be performed for all audits nor the extent to which procedures must be preformed; this will be a matter of judgment in the circumstances. Professional staffs are therefore recommended to exercise their professional judgment in the circumstances that are appropriate. SAM rating matrix system, however, provides a basis for the selection and extent of procedures, by using the information gathered in Phases I and II.

What is claimed is:

1. A method of SAM rating matrix system, comprising the steps of:
(a) establishing a rating matrix model, based upon a standard audit manual, by:
(a. 1) evaluating of internal controls to determine an internal control rating value;
(a.2) appraising a likelihood of potential errors and material misstatement to determine an error rating value;
(a.3) appraising a professional risk to determine a risk rating value; and
(a.4) appraising a materiality guideline to determine a guideline rating value; and
(b) evaluating an audit rating value in accordance with said rating matrix model, wherein said audit rating value implicate a level of likelihood of errors and a risk level of misstatement to derive an overall assessment and evaluation and forms bases of formulating an audit approach for each audit engagement.

2. The method, as recited in claim 1, wherein said audit rating value is classified into four levels, wherein when said audit rating value is graded as “Poor”, an implication is that high likelihood of errors and misstatement in financial statement with high risk, when said rating value is graded as “Moderate”, an implication is that moderate likelihood of errors and misstatement with moderate risk, when said audit rating value is graded as “Acceptable”, an implication is that acceptable likelihood of errors and misstatement with acceptable risk, and when said audit rating value is graded as “Good”, an implication is that low likelihood of errors and misstatement with low risk.

3. The method, as recited in claim 1, wherein said internal controls are evaluated by transaction walk through tests which are performed by selecting a small numbers of transactions and following said transactions through a client's system to determine whether said transactions are processed in a manner described.

4. The method, as recited in claim 2, wherein said internal controls are evaluated by transaction walk through tests which are performed by selecting a small numbers of transactions and following said transactions through a client's system to determine whether said transactions are processed in a manner described.

5. The method, as recited in claim 1, wherein a test of control for said likelihood of errors are evaluated by observation and compliance tests, wherein if a performance of a control leaves no documentary evidence, a method of testing a reliability of said control is by observation, and if said performance of said control leaves documentary evidence, said evidence of compliance is examined.

6. The method, as recited in claim 2, wherein a test of control for said likelihood of errors are evaluated by observation and compliance tests, wherein if a performance of a control leaves no documentary evidence, a method of testing a reliability of said control is by observation, and if said performance of said control leaves documentary evidence, said evidence of compliance is examined.

7. The method, as recited in claim 1, wherein said professional risk is appraised by identifying a client's business information of general economic and financial conditions, organizational conditions, management's integrity and honesty, shareholding and management structure, and client's past record.

8. The method, as recited in claim 2, wherein said professional risk is appraised by identifying a client's business information of general economic and financial conditions, organizational conditions, management's integrity and honesty, shareholding and management structure, and client's past record.

9. The method, as recited in claim 1, wherein said standard audit manual comprises the steps of:
(a) establishing said materiality guideline for audit evaluation of monetary errors;
(b) identifying material types of transactions, sources of evidence and their potential errors;
(c) knowing a client's accounting systems and controls;
(d) verifying said systems by “walkthrough” procedures wherein at least one said material type of transaction is traced; and
(e) evaluating said internal controls, the competence of accounts staff in operation in order to evaluate the degree of reliability of said systems.

10. The method as recited in claim 1, after the step (b), further comprising a step of designing said audit approach based upon said audit rating value, so as to selectively perform a system test and verification and adjust extents of said system test and verification while being time effective.

11. The method as recited in claim 2, after the step (b), further comprising a step of designing said audit approach based upon said audit rating value, so as to selectively perform a system test and verification and adjust extents of said system test and verification while being time effective.

12. The method, as recited in claim 10, wherein said system test comprises tests of control to corroborate an evaluation of said internal control and substantive tests to determine whether the transactions being processed through the client's system contain monetary errors in such a manner that said tests of control and said substantive tests are selectively performed in accordance with said audit rating value.

13. The method, as recited in claim 11, wherein said system test comprises tests of control to corroborate an evaluation of said internal control and substantive tests to determine whether the transactions being processed through the client's system contain monetary errors in such a manner that said tests of control and said substantive tests are selectively performed in accordance with said audit rating value.

14. The method, as recited in claim 10, wherein said verification comprises an analytical review for providing an input to decisions on selection and extent of an additional verification procedures, and substantive verification of key items for all potential errors for specific transactions and account balances, in such a manner that said analytical review and said substantive verification of key items are selectively performed to complete said audit engagement.

15. The method, as recited in claim 11, wherein said verification comprises an analytical review for providing an input to decisions on selection and extent of an additional verification procedures, and substantive verification of key items for all potential errors for specific transactions and account balances, in such a manner that said analytical review and said substantive verification of key items are selectively performed to complete said audit engagement.

16. A SAM rating matrix system, comprising:
a rating matrix model established base upon a standard audit manual by evaluating of internal controls to determine an internal control rating value, appraising a likelihood of potential errors and material misstatement to determine an error rating value, appraising a professional risk to determine a risk rating value, and appraising a materiality guideline to determine a guideline rating value; and
means for evaluating an audit rating value in accordance with said rating matrix model, wherein said audit rating value implicate a level of likelihood of errors and a risk level of misstatement to derive an overall assessment and evaluation and forms bases of formulating an audit approach for each audit engagement

17. The SAM rating matrix system, as recited in claim 16, wherein said internal controls are evaluated by transaction walk through tests which are performed by selecting a small numbers of transactions and following said transactions through a client's system to determine whether said transactions are processed in a manner described.

18. The SAM rating system, as recited in claim 16, wherein a test of control for said likelihood of errors are evaluated by observation and compliance tests, wherein if a performance of a control leaves no documentary evidence, a method of testing a reliability of said control is by observation, and if said performance of said control leaves documentary evidence, said evidence of compliance is examined.

19. The SAM rating matrix system, as recited in claim 16, wherein said professional risk is appraised by identifying a client's business information of general economic and financial conditions, organizational conditions, management's integrity and honesty, shareholding and management structure, and client's past record.

20. The SAM rating matrix system, as recited in claim 16, wherein said audit approach is designed based upon said audit rating value, so as to selectively perform a system test and verification and adjust extents of said system test and verification while being time effective.
